(19) United States
(12) Patent Application Publication
(10) Pub. No.: US 2023/0148594 A1
(43) Pub. Date: May 18, 2023

(54) COATED AND VARNISHED MEMBRANE COMPRISING SILVER, METHOD FOR THE PRODUCTION THEREOF AND USE THEREOF AS A VIRUCIDE

(71) Applicant: SERGE FERRARI SAS, SAINT JEAN DE SOUDAIN (FR)

(72) Inventors: Jonathan ROJON, GLATTFELDEN (CH); Valérie COURAULT, RUY MONTCEAU (FR); Annie ANDRIEU, SAINT BONNET DE MURE (FR); Philippe ESPIARD, GOUVIEUX (FR)

(21) Appl. No.: 17/920,559

(22) PCT Filed: Apr. 23, 2021
(86) PCT No.: PCT/FR2021/050714

§ 371 Date: Oct. 21, 2022

(30) Foreign Application Priority Data
Apr. 24, 2020 (FR) FR2004134

(51) Int. Cl. A01N 25/34; D06N 3/06; D06N 3/00; D06N 3/18; D06N 3/12; A01N 59/16; A01P 1/00

(52) U.S. Cl. CPC A01N 25/34; D06N 3/06; D06N 3/0063; D06N 3/183; D06N 3/123; A01N 59/16; A01P 1/00; D06N 2205/10; D06N 2203/04; D06N 2211/00; D06N 2209/147; D06N 2201/02

(57) ABSTRACT

A coated and varnished membrane, the membrane including at least one fabric having at least one face coated with at least one layer of polyvinyl chloride, and at least one varnish film on the coated face of the membrane, the varnish film including a polymeric binder and a mineral matrix in powder form including silver particles. A method for producing a membrane according to the invention. A use of a membrane according to the invention as a virucide.

### FIELD OF THE INVENTION

The invention relates to the field of coated membranes, more specifically coated fabrics typically usable as protective tarpaulins.

The invention relates more particularly to a new membrane structure which has both good resistance to abrasion, good ability to be assembled by a standard welding method, good fire resistance and antiviral action. Such a membrane can also be cleaned with commonly used antiseptics. It can be used in the medical field or for sanitary purposes.

### BACKGROUND OF THE INVENTION

In the field of coated membranes, textiles coated with a material made from polyvinyl chloride (or PVC), typically flame-retardant plasticized PVC, are very commonly used. These PVC-coated textiles have the advantage of being easily assembled by heat-welding, which allows manufacturing adapted to the shape to be produced while preserving the waterproofness of the membrane.

On the other hand, silver, for example in the form of particles of nanometric size (or nanoparticles), is used in the medical field mainly for its antibacterial effects. To date, silver nanoparticles are used in dressings where they have been incorporated by impregnation, or are dispersed in polymers molded into blocks constituting all or part of medical devices such as, for example, catheters or orthopedic implants, particularly in order to limit the formation of pathogenic biofilm. Finally, textiles such as surgical drapes or surgical masks may also contain silver nanoparticles, incorporated by impregnation and present within the material. However, these textile articles are not waterproof or heat-weldable. In these different applications, silver is incorporated mainly by impregnation or extrusion.

Silver is also known for applications outside the medical field. For example, incorporated into shoes or clothing (socks, t-shirts, hoods, etc.), silver particles make it possible to fight against bacteria that cause bad odors and also prevent fungal infections.

In this case, they are incorporated by extrusion during spinning or by impregnation during the finishing of the textile. Integrated into washing machines, the silver particles release Ag⁺ ions during the washing cycle, which allows the laundry to be more thoroughly sanitized.

Thus, silver is commonly used for its bactericidal properties. Now, it was recently observed that silver also has antiviral properties (Thesis No. 120, R. Chauvet, “Applications of silver nanoparticles in therapy”, October 2018, University C. Bernard Lyon 1—Faculty of Pharmacy and Institute of Pharmaceutical and Biological Sciences). The antiviral activity of silver is in the early stages of research.

Indeed, bacteria and viruses are different entities, whether by size (viruses are on average about a thousand times smaller in size than bacteria, which have a minimum size of about 1 μm), by structure (the virus is considered a biological entity and the bacterium is a living organism), or by genetic material (bacteria are prokaryotes with DNA and RNA; viruses have only one of these acids).

Patent application CN 108894005 discloses an antibacterial artificial leather using polyvinyl chloride (PVC) made from a base fabric, which may be a cloth, an intermediate layer bonded to the fabric layer by an adhesive layer, with a surface PVC layer and a protection layer against the environment. The protection layer against the environment plays a role of varnish and comprises water-based polyurethane and an antibacterial agent including an organic antibacterial component composed of nanoscale particles, which is preferably nano chitosan, and an inorganic antibacterial component including nanoscale particles. The inorganic antibacterial component may be nano silver, nano zinc, nano copper, or nano titanium or their oxides. The protection layer against the environment is made from an aqueous, non-solvent medium. The antibacterial agent must include an organic component and an inorganic component in order to obtain the desired antibacterial effect (as demonstrated in Comparative Examples 2 and 3).

At the present time, there are no surface-coated textiles comprising antiviral properties while retaining weldability properties and resistance to abrasion and washing (cleanability), which can be used in the medical field or for sanitary purposes, such as for modular sanitary structures, tents, partition walls in hospitals, stretchers, or even mattress covers or any other membrane that may be useful in the vicinity of patients.

Currently, there is a need for such a material in order to limit the spread of viruses and, therefore, an epidemic or even a pandemic.

For that reason, the aim of the invention is to propose a coated membrane having an antiviral action, as well as a method for manufacturing such a membrane.

### SUMMARY OF THE INVENTION

According to a first aspect, the invention relates to a coated and varnished membrane, said membrane comprising at least one fabric having at least one face coated with at least one layer of polyvinyl chloride, and at least one varnish film on said coated face of the membrane, said varnish film comprising a polymeric binder and a mineral matrix in powder form comprising silver.

According to the invention, the coated face of the fabric may be coated with at least one layer of polymer, for example a layer of polyurethane or a layer of PVC, then with the layer of polyvinyl chloride. Therefore, the polyvinyl chloride layer is an outer layer (i.e., the furthest from the fabric) on which the varnish film rests, itself in contact with the outside (relative to the fabric).

One or more layers of polymer(s) may be deposited on each face of the membrane without one face being necessarily coated with the same number of layers, and layers of the same nature and thickness, as the corresponding other face.

Silver, which has the antiviral function, is present within the mineral matrix (or inorganic matrix). The matrix is in the form of a powder comprising an atomic network in which the silver atoms are incorporated. In other words, the silver is aggregated in the matrix, preferably in the form of silver particles. The matrix serves as a reservoir for silver which will be available on the surface of the composite membrane to destroy the viruses. Silver may also be on the surface of the grains of the mineral matrix.

There are several mineral matrices on the market that can contain silver. Said mineral matrices include, for example:
Phosphate glass containing oxides of phosphorus, silicon, calcium, magnesium and possibly other elements; these products are sold, in particular, by Ishizuka under the name of Ionpure® or by Sanitized under the name of Sanitized® BCA 2141.
Zeolites, for example of formula Ag₂O/Al₂O₃/SiO₂/H₂O, particularly sold by Sinanen under the name Zeomic®.
Zirconium phosphate, mixed or not with zinc oxides, sold in particular by Milliken under the references AlphaSan® RC7000 or AlphaSan® RC5000.
Titanium dioxide coated with silver chloride, sold in particular by Clariant under the name of JMAC.

According to the invention, the matrix must have a particle size compatible with the thickness of the varnish film, i.e., generally a particle size strictly less than 20 μm, preferably strictly less than 5 μm. In all cases, this size is generally greater than, or equal to, 0.1 μm. The size of the matrix particles is most often in the range of 0.1 to 10 μm, preferably 0.1 to 5 μm. Any combination of these lower and upper values is within the scope of the invention. The particle size is thus qualified as micrometric.

According to the invention, the term “size” is understood to mean the largest dimension of the particle.

According to a preferred embodiment, the d98 of the matrix particles containing the silver is less than 18 μm, preferably less than 10 μm, and the d50 of the matrix containing the silver is less than or equal to 6 μm, preferably less than or equal to 3 μm, for example equal to 1.5 or 1.6 μm. The designation “d98” means the maximum size of 98% of the particles (by number). The designation “d50” means the maximum size of 50% of the particles (by number).

According to a preferred embodiment, the d90 of the matrix particles containing the silver is less than 10 μm, preferably less than 6 μm, for example equal to 3.1 or 3.2 μm and the d10 of the matrix containing the silver is less than or equal to 2 μm, preferably less than or equal to 1 μm, for example equal to 0.5 or 0.6 μm. The designation “d90” means the maximum size of 90% of the particles (by number). The designation “d10” means the maximum size of 10% of the particles (by number).

According to particularly preferred embodiments, the values of the particle sizes of the matrix according to the invention comply with the values given above for the d98, d90, d50 and d10, all combinations of these values being possible (for example, a d10 less than 2 μm and a d90 less than 6 μm).

According to a preferred embodiment, the refractive index of the matrix comprising the silver is as close as possible to the refractive index of the varnish film in which it is incorporated. This advantageously makes it possible to provide a film of transparent varnish. The varnish film according to the invention generally has a refractive index, usually measured by ellipsometry, close to 1.512. Therefore, according to said preferred embodiment, the matrix containing the silver has a refractive index in the range of 1.45 to 1.55, preferably from 1.5 to 1.52. For example, the Sanitized® BCA 2141 product from Sanitized has a refractive index of 1.507.

The silver content in the matrix is generally between 0.01 and 10%, preferably between 0.1 and 5%, more preferably between 1 and 3%, in % by weight relative to the matrix.

According to the invention, it is particularly preferred that the membrane not contain any other antibacterial compound than silver (which can play this role in addition to its antiviral action). It is even more particularly preferred that the membrane not contain any organic antibacterial compound. It is particularly excluded that the membrane contains chitosan, in any form whatsoever.

According to one embodiment of the invention, the mass content of silver in the varnish film is in the range of 0.01 to 5%, preferably 0.05 to 3%, even more preferably 0.05 to 2%. This content is expressed in relation to the silver element and calculated once the film has dried.

Unexpectedly, these macro-sized matrix powders have been found to exhibit antiviral activity due to the presence of silver within the matrix network.

The membrane according to the invention is most often presented in a strip of suitable length, typically 50 m, and with a width of up to 5 m. Thus, said membrane is easily rollable or foldable, and transportable, which facilitates possible handling and logistics operations.

Unexpectedly, the silver particles present in the varnish confer antiviral activity on the coated and varnished membrane, while maintaining its usual properties, i.e., resistance to cleaning by most antiseptics used in sanitary and/or medical fields, as well as abrasion resistance. Thus, such a membrane has a valuable service time. Another of the advantages of the invention is that the coated and varnished membrane can be easily welded, typically by heat-welding, to another membrane, generally coated and varnished, without losing its antiviral action. This allows a modular assembly of the membranes according to the invention based on the needs of the end user, which is particularly valuable.

Thus, the membrane according to the invention makes it possible to limit, or even stop the proliferation of viruses in the environments used or inhabited by humans, by an antiviral action which destroys viruses by surface contact, in the absence of any human cleaning intervention, in just a few minutes of contact.

According to the invention, the term “fabric” is understood to mean a textile material. The fabric constitutes the core or reinforcement of the coated and varnished membrane.

Preferably, the fabric is selected from wovens, nonwovens, grids, knits, and mixtures thereof, preferably from wovens and nonwovens.

According to one embodiment of the invention, the fabric is made from textile material and comprises yarns or fibers made from a material selected from the group comprising glass, polyesters including aromatic polyesters (such as, for example, the commercial product Vectran® from Kuraray), polyamides including aromatic polyamides (such as, for example, the commercial product Kevlar® from Dupont), polyacrylates, viscoses, nylons, cottons, polyvinyl acetates, polyvinyl alcohols and mixtures thereof. Preferably, the fabric is a woven or a non-woven polyester, typically high tenacity polyester.

According to a preferred embodiment of the invention, the layer of polyvinyl chloride comprises polyvinyl chloride, at least one plasticizer and at least one heat stabilizer. The plasticizer is generally present in the range of 30 to 100 parts by weight based on 100 parts by weight of PVC. The heat stabilizer is generally present in the range of 0.5 to 10 parts by weight based on 100 parts by weight of PVC.

The polyvinyl chloride layer is generally deposited on the fabric or on the fabric previously coated with at least one layer of polymer, such as a layer of polyurethane or PVC, by a coating step using a paste with which the membrane is coated, in a manner known to a person skilled in the art. Usually, PVC resin in powder form (obtained from emulsion or micro-suspension polymerization of vinyl chloride monomer) is dispersed in a liquid plasticizer, which gives the paste called plastisol. However, it can also be deposited by extrusion or calendering.

The PVC layer may also contain at least one additive such as a pigment, for example a nickel titanate, or a titanium dioxide; at least one flame retardant filler such as antimony trioxide, alumina trihydrate, zinc borate or calcium carbonate; a fungicide and/or any other additive known to a person skilled in the art.

The plasticizer is selected in the usual way for a person skilled in the art, according to the applications and the properties required for the membrane. It is generally of the ester type, typically selected from phthalates, phosphates and adipates. For example, if cold hardiness is required, an adipate-type plasticizer such as dicotyl adipate (DOA) is typically used. There are many commercial plasticizers such as diisononyl phthalate (DINP), available from BASF and Exxon, for example, but also diisodecyl phthalate (DIDP), dioctylterephthalate (DOTP), di(2-propylheptyl) phthalate (DPHP), 1,2-cyclohexane dicarboxylic acid (DINCH), 2-ethylhexyl diphenyl phosphate (Santicizer® 141 from Valtris), tris(2-ethylhexyl) trimellitate (TOTM) or a biobased plasticizer such as Polysorb® ID37 from Roquette.

Usually, the thermal stabilizer, which is added to the plastisol, is a metallic salt such as a barium and zinc salt, or a calcium and zinc salt, or a tin-based compound. However, the thermal stabilizer may also be an organic compound. It makes it possible to gel the plastisol at a temperature typically between 140° C. and 200° C. without degrading the PVC.

A standard plastisol formula that may be used according to the invention is the following, given in parts by weight:
PVC resin: Lacovyl® PB1302 from Kem One: 100
Plasticizer: Jayflex® DINP from Exxon: between 50 and 100, for example 60
Thermal stabilizer: made from barium and zinc salts: Mark® 962 from Galata: between 1 and 5, for example 3
Pigment: Kronos® 2220 titanium dioxide from Kronos: between 0 (excluded) and 40, for example 7
Flame retardant filler: Blue star MT® antimony trioxide from Campine: between 0 (excluded) and 60, for example 10.

According to one embodiment of the invention, the varnish film has an average thickness in the range of 0.5 to 20 μm, preferably 1 to 12 μm, even more preferably 2 to 10 μm. For example, the average thickness is between 4 and 8 μm. The appearance of the outer surface of the film follows the appearance of the PVC layer before the film is deposited and is therefore not completely smooth. In addition, the thickness may vary from one point to another of the film, typically by ±3 μm.

Advantageously, the varnish film is transparent.

The polymeric binder generally comprises an acrylic or methacrylic (co)polymer, or a polyurethane.

According to one embodiment, the polymeric binder preferably comprises an acrylic polymer or a methacrylic polymer such as polymethyl methacrylate (PMMA) or polybutyl methacrylate or polyethyl methacrylate, and their copolymers.

According to the invention, the term “copolymer” is understood to mean a polymer resulting from the copolymerization of at least two, chemically different, types of monomers. According to the invention, the term “homopolymer” is understood to mean a polymer resulting from the polymerization of a single type of monomer. According to the invention, the term “(co)polymer” is understood to mean polymer or copolymer.

The acrylic or methacrylic polymer, including polymethyl methacrylate (PMMA), and their copolymers, is an amorphous thermoplastic polymer which has good aging properties, good chemical resistance, good adhesion to flexible PVC, as well as good recoverability. These advantageous properties make it possible to produce a varnish having good resistance during the assembly of the membranes according to the invention, for example by high-frequency welding. The polymeric binder most often has a high glass transition temperature (Tg), preferably in the range of 100 to 125° C. in order to ensure the durability of the assemblies with respect to temperature.

According to another embodiment, the polymeric binder comprises a polyurethane, such as a polyester polyurethane, a polyether polyurethane, a polycarbonate or polyester copolymer polyurethane, such as, for example, Impranyl® XP2610 from COVESTRO, or Rowathal® MVP22116 from ROWA.

The varnish film generally also comprises at least one co-binder (or secondary binder), generally mixed with the binder. The co-binder is preferably selected from the group comprising fluorinated (co)polymers and homopolymer and copolymer PVC resins, even more preferably from homopolymer PVC resins with a molecular mass (KWert) preferably less than 65. As a result, modulating the adhesion and flexibility of the varnish film is advantageously possible.

According to a preferred embodiment, the varnish film may also comprise at least one additional additive selected from UV stabilizers, matting agents, heat stabilizers and pigments.

The UV stabilizer is preferably present when the coated and varnished membrane is to be used outdoors. The UV stabilizer is preferably selected from benzotriazoles, or triazines, even more preferably from triazines, for example the commercial product Tinuvin® 400 (hydroxytriazine) from BASF.

The matting agent is generally organic or inorganic, preferably selected from polymeric additives of the polymethyl urea type, or inorganic additives of the fumed silica type. It usually makes it possible to give the varnish film the desired finish (gloss, satin, matte, etc.).

The heat stabilizer is typically needed when a PVC resin (homopolymer or copolymer) is used as a co-binder. The heat stabilizer is usually a metal salt, such as a barium and zinc salt, or a calcium and zinc salt, or is made from tin, preferably of the Ba/Zn type, or mixtures thereof.

The varnish film may be transparent or colored, typically by adding at least one pigment to the varnish. The pigment is, for example, selected from the group comprising titanium dioxide (white), carbon black, phthalocyanine, and mixtures thereof. Particularly preferably, the pigment does not comprise a sulfur atom.

Particularly preferably according to the invention, the varnish film does not comprise a sulfur compound. This advantageously makes it possible to preserve the antiviral property of the membrane, linked to the silver particles present in the varnish.

According to a variant, the varnish and the plastisol defined above may be mixed, which makes it possible to obtain a mixture called organosol which is used in the same way as the varnish. The organosol advantageously contains a plasticizer. This variant may be advantageously used if great flexibility is particularly desired for the varnish.

According to a second aspect, the invention relates to a method for manufacturing a membrane according to the invention, comprising the following steps:

(a) providing a coated membrane comprising at least one fabric coated on at least one face with at least one layer of polyvinyl chloride;

(b) providing a varnish comprising at least one solvent, at least one polymeric binder, and at least one mineral matrix in the form of a powder comprising silver;

(c) depositing on the coated face of step (a) a varnish film from step (b), to a thickness within the range of 0.5 to 20 μm; and

(d) drying the varnish film from step (c), leading to obtaining the coated and varnished membrane.

This is thus referred to as deposition of varnish by the solvent route.

According to the invention, the term “varnish” is understood to mean a liquid, colored or not, which has the ability to form a film after being applied to a substrate and drying. The polymeric binder, which comprises at least one organic synthetic compound, is one of the essential components of the varnish.

The varnish from step (b) may be a commercial product to which the matrix is added, generally by mixing. It is also possible to manufacture the varnish as is known to a person skilled in the art, typically by mixing the constituents of the varnish. As explained above, when it includes an additive or an additional additive, this additive has also been mixed within the varnish, as is known to a person skilled in the art.

The solvent (or organic solvent) is generally selected from solvents capable of dissolving the polymeric binder, depending on the nature of the polymeric binder. Generally, and preferably, the solvent is not an aqueous solvent or water. Preferably, the solvent is selected from the group comprising ketones such as methyl ethyl ketone (or MEK), acetone, diethyl ketone, methyl isobutyl ketone, diisobutyl ketone, gamma butyrolactone or cyclohexanone; alcohols (non-cyclic) such as ethyl alcohol, isopropyl alcohol, N-propyl alcohol, benzyl alcohol or furfuryl alcohol; cyclic alcohols such as cyclohexanol; acetates such as ethyl acetate or butyl acetate; ketone alcohols such as diacetone alcohol (DAA); cyclic ethers such as tetrahydrofuran (THF), propylene glycol monoethyl ether acetate, methoxypropyl acetate; aromatic solvents such as toluene or xylene; hydrocarbon solvents such as heptane or cyclohexane; N,N-dimethylformamide (DMF) and their mixtures.

According to a variant, the varnish also comprises plastisol. The plastisol is as explained above.

Advantageously, the method of the invention makes it possible to apply on a coated membrane at least a deposit of a few micrometers of varnish in which silver, supported by a matrix in the form of powder, has been dispersed, and to cause it to adhere, while retaining the properties of said membrane, in particular its weldability.

Weldability is the ability of the coated and varnished membrane to be welded. The main welding methods of PVC coated membranes are hot air welding, high frequency welding, heat welding and ultrasonic welding. Advantageously, and unexpectedly for a person skilled in the art, the varnish film according to the invention does not form a barrier to the fusion of the two PVC layers of two different membranes and does not hinder their interpenetration.

Thus, advantageously, the varnish according to the invention adheres to the coated membrane and is resistant to abrasion, water, dirt and certain detergents. If necessary, the varnish according to the invention can be formulated to have a particular desired appearance (matt, glossy, etc.) or a particular resistance (such as UV resistance in the event of outdoor use of the membrane according to the invention), as explained above.

According to a third aspect, the invention relates to a use of a membrane according to the invention, or manufactured according to the method according to the invention, as a virucide, generally in the field of technical textiles.

### BRIEF DESCRIPTION OF THE DRAWINGS

The way to implement the invention, as well as the advantages which result therefrom, emerge from the following description of the embodiments, in support of the appended FIGS. 1 to 5 in which:

FIG. 1 is a schematic sectional view of a first embodiment of the membrane of the invention.

FIG. 2 is an enlargement of FIG. 1.

FIG. 3 is a schematic sectional view of a second embodiment of the membrane of the invention.

FIG. 4 is an enlargement of FIG. 3.

FIG. 5 is a photograph taken by transmission electron microscopy (TEM) of powder particles according to the invention. It shows the micrometric dimension of such particles.

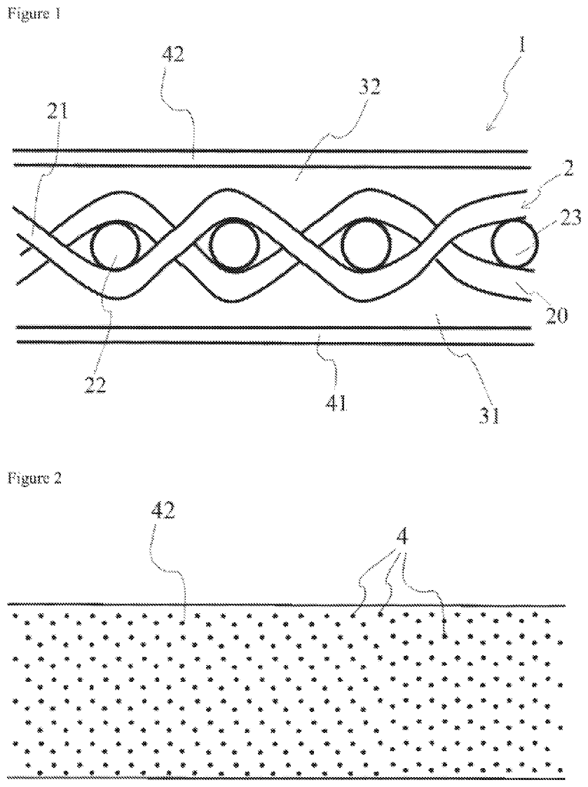

Obviously, the dimensions and proportions of the elements illustrated in FIGS. 1 to 4 may have been exaggerated in relation to reality, and were given only for the purpose of making it easier to understand the invention.

### DETAILED DESCRIPTION OF THE INVENTION

The coated and varnished membrane 1 of FIG. 1 comprising a core or textile reinforcement 2 consisting of a weave of high tenacity polyester yarns, formed of warp yarns 22 intersecting with weft yarns 21 and 23. The woven core 2 was coated on both faces, respectively 31 and 32, with a layer of PVC. According to the invention, two films of varnish, respectively 41 and 42, were deposited on each coated face, the film 42 being enlarged in FIG. 2. The film 42 comprises a matrix in the form of a powder 4 comprising silver, said powder being dispersed within the film 42.

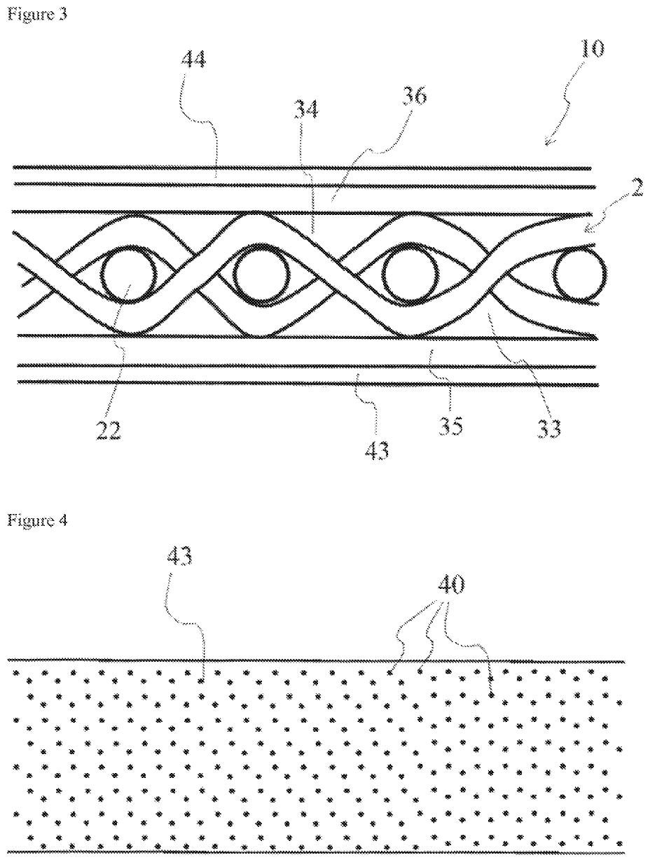

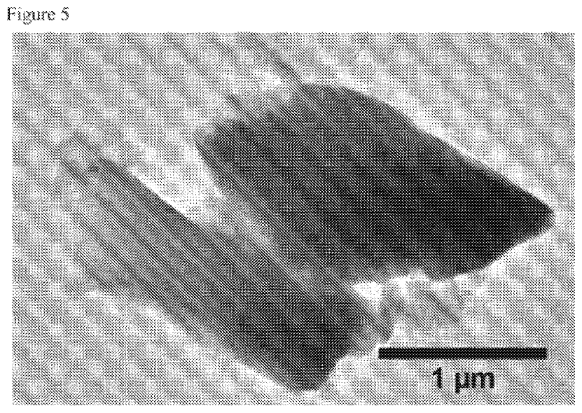

The coated and varnished membrane 10 of FIG. 3 comprises the same core or textile reinforcement 2. The woven core 2 was coated on both faces with two successive layers of PVC, respectively 34 then 36, on one face, and 33 then 35 on the other face. According to the invention, two films of varnish, 44 and 43 respectively, were deposited on each coated face, the film 43 being enlarged in FIG. 4. The film 43 comprises a matrix in the form of a powder 40 comprising silver, said powder being dispersed within the film 43.

### EXAMPLES

Different tests were carried out on the same membrane coated with the same varnish film. To that end, a solvent-borne varnish was deposited on one face covered with a membrane made from high tenacity polyester fabric coated with PVC on each face.

The matrix comprising silver particles that was used was Sanitized® BCA 2141, phosphate glass from Sanitized, photographed by TEM in FIG. 5.

The varnish was manufactured 48 hours before its use and stored at a temperature above 5° C.

The varnish had the following composition (in parts by weight):

Composition of the solvent-based varnish (by weight)

The starting varnish is a commercial product, varnish Rowakryl® G34902 (dry extract 15.5%), from Rowa, at 99.15% by weight, to which 0.85% by weight of Sanitized® BCA2141 was added.

The final dry extract of the varnish was 16.25%.

The varnish includes the following components:

Ketone solvent: Methyl ethyl ketone

Ester solvent: Methoxypropyl acetate

Polymer binder: Polymethyl methacrylate

Polymer co-binder: PVC (homopolymer)

Ca/Zn heat stabilizer.

The thickness of the varnish once dried was on average 6.5 μm. It was checked by optical measurement on a microtome section of the slice of the membrane.

The matrix content in the varnish (dry extract) was 5.2%, the silver content in the matrix was 1.8%. Therefore, the silver content of the dry varnish was 0.09%.

All the tests were also carried out on a comparative coated and varnished membrane, i.e., a membrane prepared with the varnish Rowakryl® G34902 without silver, its formula being identical to the coated and varnished membrane according to the invention, except for the presence of silver.

Efficacy Test Against Viruses

Preliminary trials carried out to verify the feasibility of the test:
cell cytotoxicity indicator
membrane residual activity indicator

Controls made during the tests:
cell cytotoxicity indicator
membrane residual activity indicator
positive controls on 304 stainless steel disc

The virological analyzes are carried out by determining the infectious titers on MRC5 cells (ATCC CCL-171) in limiting dilution. Cytopathogenic effects (CPE) readings are taken after 6 days of incubation at 37° C. and 5% CO₂.

The test was carried out compared to a reference coated membrane, i.e., a membrane that did not contain silver.

The human coronavirus HCoV-229E, which is part of the enveloped alpha coronavirus family, was used in the test.

The contact time between the membrane (comparative or according to the invention) and the solution containing the virus is 60 min.

Two environmental conditions were tested:
Cleanliness condition standardized in medical field: 0.3 g/l BSA
Complex interference condition: saliva and respiratory mucus.

The solution comprising the virus was deposited in an amount of 50 to 100 μL and the amount of virus deposited was 10⁵ TCID50 (for 50% Tissue Culture Infectious Dose: titer required to cause infection in 50% of the inoculated cell cultures).

The results for the coated and varnished membrane according to the invention compared to the comparative membrane (without silver) was a reduction of 99.78% in the viral load at 60 min, for the virus alone, and a 99.46% reduction in viral load at 60 min, for the virus with mucus and saliva.

Conformity was established for a value strictly greater than 90% after 1 hour of contact. Consequently, the tests demonstrated the antiviral function of the membrane according to the invention.

Test Demonstrating Weldability

Tests were carried out on an industrial high-frequency bench to verify that the varnish film did not form a barrier to the fusion of two layers of PVC and did not interfere with their interpenetration during the welding of two membranes according to the invention. After this assembly by high frequency, the force required to open the weld was measured, according to the protocol described in the EN 15619 standard Appendix C.

The value found had to be equal to, or greater than, the value stated in the product datasheet, which is 6 daN over a width of 5 cm. The values measured were 7.9 daN/5 cm for the coated and varnished membrane according to the invention, against 7 daN/5 cm for the comparative membrane, which, therefore, validated the test for the two membranes.

Test Demonstrating Non-Irritation of the Skin

Tests were carried out according to the protocol described in the OEC TG 439 standard (In vitro skin irritation: reconstructed human epidermis test method. June 2019) to verify that the varnish film was not irritating when in contact with the skin.

Skin irritation was assessed after 35 min of exposure followed by 25 min of exposure at room temperature, cleaning of the product and 42 hours of post-exposure incubation. The viability of EpiDerm™ tissue was measured via the enzymatic conversion of the vital dye MTT (3-(4,5-dimethylthiazol-2-yl)-2,5-diphenyltetrazolium bromide, CAS No. 298-93-1) in comparison with tissues treated with a negative control substance (% viability). According to the MTT results (100%) and the predictive model, the product was classified (UN GHS classification) as “non-irritating to the skin”.

Virucidal Efficacy Test After Wear of the Varnish on the Coated Membrane

To verify the good virucidal efficacy of the varnish film on the coated membrane after wear, a virucidal activity test after 5000 Martindale cycles from the ISO 21 702 (2019) standard was used both on the coated membrane and on a non-active surface (test control surface), according to different contact times (5 min, 15 min and 60 min), the interfering substance being a mucus-saliva mixture and the virus being the human coronavirus HCoV-229E.

The results were as follows:

| | | Contact | Logarithmic | Virucidal |
|---|---|---|---|---|
| | Interfering | time | reduction | efficacy |
| Product | substance | (min) | (Log10) | (%) |
| Coated | Mucus-saliva | 5 | 2.17 | 99.32% |
| membrane | | 10 | 3.37 | 99.96% |
| after 5000 | | 15 | 3.87 | 99.99% |
| Martindale | | | | |
| cycles | | | | |

The tests thus show efficacy after wear.

Varnish Adhesion Test on the Coated Membrane

To check the good adhesion of the varnish film on the coated membrane, an ISO 5981 standard scrub fluxmeter test was carried out. This test applies strong movements to the membrane, capable of causing the varnish to peel off if the adhesion is too weak. After 2000 cycles of movement, scotch tape was applied to the coated and varnished membrane to verify that the varnish did not come off: the varnish remained on the membrane and did not come off at the same time as the tape. Adhesion was thus considered to be compliant for the membrane according to the invention, as for the comparative membrane.

Cleanability Tests of the Coated and Varnished Membrane According to the Invention

The resistance to betadine and eosin stains of a coated and varnished membrane according to the invention was tested in accordance with the following procedure:
measuring the initial color of the fabric and recording it
taking a non-woven wipe as used in hospitals
impregnating it with betadine or eosin and rubbing it on the fabric. Leaving to “dry” for 10 min.
wiping with a clean dry wipe.
cleaning with high surface disinfectant detergent Anios (didecyldimethylammonium chloride and polyhexamethylene biguanide hydrochloride).
remeasuring the Delta E (CMC) after cleaning
   if Delta E (CMC) <2 excellent cleaning
   if Delta E (CMC) <5 good cleaning
   if Delta E (CMC) <7 average cleaning
   if Delta E (CMC) >7 poor cleaning

The membrane according to the invention made it possible to obtain results qualifying the cleaning as excellent, whether for betadine or for eosin. The comparative membrane gave the same result.

Test Results

| | | | Varnish | Weld- | |
|---|---|---|---|---|---|
| | | | adhesion | ability | Coating |
| | % Ag | Anti- | (after | (greater | resistance |
| | in the | viral | 2000 | than 6 | to |
| | varnish | action | cycles) | daN/5 cm) | cleaning |
| Comparative | 0% | None | OK | 7 | Excellent |
| membrane | | | | | |
| Membrane | 0.09% | More | OK | 7.9 | Excellent |
| according | | than 90% | | | |
| to the | | reduction | | | |
| invention | | after 60 min | | | |

“OK” means that the test is considered conclusive: the coated and varnished membrane according to the invention is compliant: the property was validated.

In conclusion, it was demonstrated that the coated and varnished membrane according to the invention has an antiviral action while retaining the desired properties of varnish adhesion, weldability and resistance to cleaning.

1. A coated and varnished membrane, said membrane comprising at least one fabric having at least one face coated with at least one layer of polyvinyl chloride, and at least one varnish film on said coated face of the membrane, said varnish film comprising a polymeric binder and a mineral matrix in powder form comprising silver.

2. The membrane according to claim 1, wherein the fabric is selected from wovens, nonwovens, grids, knits, and mixtures thereof.

3. The membrane according to claim 1, wherein the fabric is made from textile material and comprises yarns or fibers made from a material selected from the group comprising glass, polyesters, polyamides, polyacrylates, viscoses, nylons, cottons, polyvinyl acetates, polyvinyl alcohols and mixtures thereof.

4. The membrane according to claim 1, wherein the layer of polyvinyl chloride comprises polyvinyl chloride, at least one plasticizer and at least one heat stabilizer.

5. The membrane according to claim 1, wherein the varnish film has an average thickness in range of 0.5 to 20 μm.

6. The membrane according to claim 1, wherein a mass content of the silver in the varnish film is in a range of 0.01 to 5%.

7. The membrane according to claim 1, wherein matrix particles comprising the silver have a size strictly less than 20 μm.

8. The membrane according to claim 1, wherein the polymeric binder comprises an acrylic or methacrylic (co)polymer or a polyurethane.

9. The membrane according to claim 1, wherein the varnish film further comprises at least one co-binder selected from the group comprising fluorinated (co)polymers and homopolymer and copolymer PVC resins.

10. The membrane according to claim 1, wherein the varnish film further comprises at least one additional additive selected from UV stabilizers, matting agents, heat stabilizers, and pigments.

11. A method for manufacturing a membrane according to claim 1, comprising the following steps:
(a) providing a coated membrane comprising the at least one fabric coated on the at least one face with the at least one layer of polyvinyl chloride;
(b) providing a varnish comprising at least one solvent, at least one polymeric binder, and at least one mineral matrix in the form of a powder comprising the silver;
(c) depositing, on the coated face of step (a), a film of the varnish from step (b), to a thickness in a range of 0.5 to 20 μm; and
(d) drying the varnish film from step (c), resulting in obtaining the coated and varnished membrane.

12. The method according to claim 11, wherein the solvent is selected from the group comprising ketones, alcohols, cyclic alcohols, acetates, ketone alcohols, cyclic ethers, aromatic solvents, hydrocarbon solvents, and mixtures thereof.

13. The membrane according to claim 1, said member being configured for use as a virucide.

14. The membrane according to claim 1, wherein the varnish film has an average thickness in a range of 1 to 12 μm.

15. The membrane according to claim 1, wherein the varnish film has an average thickness in a range of 2 to 10 μm.

16. The membrane according to claim 1, wherein a mass content of the silver in the varnish film is in a range of 0.05 to 3% by weight.

17. The membrane according to claim 1, wherein a mass content of the silver in the varnish film is in a range of 0.05 to 2% by weight.
